(19) United States
(12) Patent Application Publication
(10) Pub. No.: US 2025/0222849 A1
(43) Pub. Date: Jul. 10, 2025

(54) FOLDABLE TABLE SYSTEM

(71) Applicant: B/E Aerospace Fischer GmbH, Landshut (DE)

(72) Inventor: Marcin Szymon Kolodziejczak, Wroclaw (PL)

(21) Appl. No.: 18/978,927

(22) Filed: Dec. 12, 2024

(30) Foreign Application Priority Data
Jan. 9, 2024 (EP) 24461502.7

(51) Int. Cl. B60N 3/00; B60N 2/32; B64D 11/06

(52) U.S. Cl. CPC B60N 3/004; B60N 2/32; B64D 11/0638

(57) ABSTRACT

A foldable table system includes a table having a first end and a second end, a table top surface, a table bottom surface, and a cavity defined between the table top surface and the bottom surface. The system includes a hinge assembly connected by pivot arms to the table about which the table is pivoted between a stowed position and an open position. The system includes a locking system. The locking system includes a lever assembly, side locking pins, rear locking pins, and an actuator for operation by a user, where the locking system is biased to a default state in which the lever assembly drives the side locking pins and the rear locking pins to extend from the table, and where operation of the actuator operates the lever assembly to retract the side locking pins and the rear locking pins into the cavity.

### CROSS-REFERENCE TO RELATED APPLICATIONS

The present application claims the benefit of European Patent Application No. 24461502.7, filed Jan. 9, 2024, which is herein incorporated by reference in the entirety.

### TECHNICAL FIELD

This disclosure relates to a foldable table system mounted in a seat back, e.g., a seat in a vehicle or aircraft, e.g., airplane or helicopter.

### BACKGROUND

In various settings, such as, but not limited to, in vehicles or aircraft, tables may be mounted to seats or provided in seat areas for use. The tables are mounted such that they can be folded out for use or folded back to be stowed in a part of the seat structure when not in use. Such tables are particularly useful when, for example, space is restricted and/or where, for reasons of safety, convenience, or comfort, the table should not always be in the opened-out state. It is known, for example, to have foldable tables or surfaces mounted in seat arms or seat backs in passenger vehicles or aircraft. In some cases, the table is mounted to the back of a seat back rest such that a passenger in a seat behind the seat in which the table is mounted, can access and fold out the table from the back of the back rest in front of them. In other systems, the table can be stowed in a recess in a seat arm rest and folded out over the lap of the user of the seat when needed. In other systems, the table may be mounted in and stowed in the front of the seat back against which the back of a person in the seat would usually rest. With these systems, the bottom surface of the table (with reference to its opened out state) is provided with cushioning so that when the table is stowed, the seat back appears and functions as a regular seat back. If, however, the seat is not in use, the table can be folded out so that the seat provides, instead, a table area, e.g., for a person in an adjacent seat or just to make use of the vacant seat to provide a useful table surface. Such tables are often provided in helicopters where space is restricted and where a pilot or passenger may need a useful table surface rather than a spare seat. Such systems can also be used in aircraft, e.g. in Business or first class seats, where passengers are often given a seat with an adjacent seat next to them being kept vacant to provide the passenger with more space and privacy. In such cases, the vacant seat can then provide a table for that passenger.

These table systems are also often provided with cup or beverage holders in the form of holes or receptacles. These may be formed in the table itself, or may be attached to and foldable from the table.

In all such table systems, it is desirable that, at least in the stowed state, the table is locked in place. This is especially important in high vibrational environments such as in vehicles or aircraft. Often, the table is secured in the stowed position by a simple latch extending between the seat back and the table that can be opened by simple rotation by a user. Where the table is in the front of the seat back, and is provided with cushioning, often the seat is just held in place by friction and due to gravity and the slightly inclined angle of the seat.

While such table systems have generally proved fit for purpose, there is always a desire to improve the systems in terms of their ease and safety of use, space saving design, and secure stowing. There is also a desire, especially in high motion or vibrational uses, to ensure that the table is locked in its closed position and preferably also in its open position. Where the back of the table is provided with cushioning to provide a seat back when stowed, the cushioning can also interfere with the table opening to a flat orientation, and there is a desire to mitigate this.

### SUMMARY

According to this disclosure, there is provided a foldable table system assembled in a seat back and provided with a built-in locking system. More specifically, there is provided a foldable table system for incorporation in a seat back, the system including: a table having a first end and a second end, a table top surface extending from the first end to the second end, a table bottom surface extending from the first end to the second end, and a cavity defined between the table top surface and the bottom surface; a hinge assembly connected by pivot arms to the first end of the table about which the table is pivoted between a stowed position and an open position; and a locking system located within the cavity, the locking system including a lever assembly, side locking pins connected to a side locking assembly of the lever assembly, rear locking pins connected to a rear locking assembly of the lever assembly, and an actuator for operation by a user, where the locking system is biased to a default state in which the lever assembly drives the side locking pins and the rear locking pins to extend from the table, and where operation of the actuator by the user operates the lever assembly to retract the side locking pins and the rear locking pins into the cavity.

Also provided is a seat incorporating such a table assembly.

### BRIEF DESCRIPTION

Examples of the table system will now be described with reference to the drawings. It should be noted that these are examples only and variations are possible within the scope of the claims.

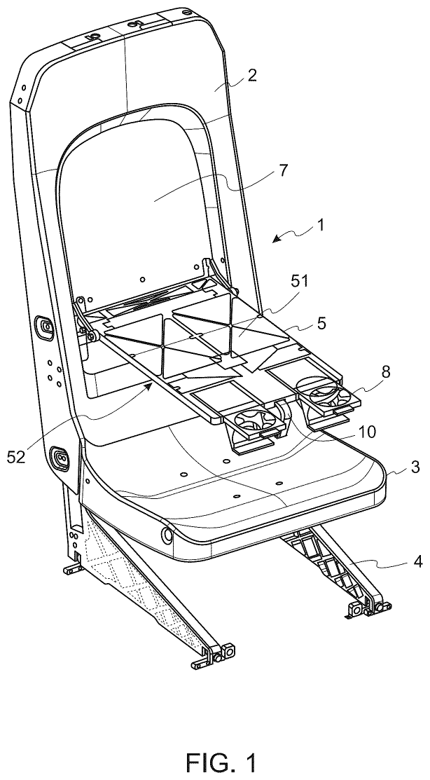

FIG. 1 shows a seat with a foldable table in an open position, in accordance with one or more embodiments of the present disclosure.

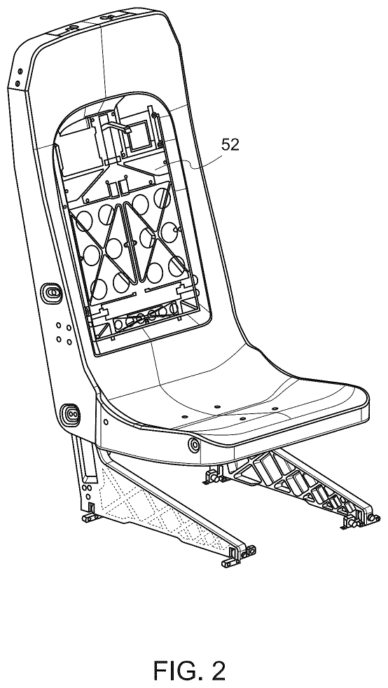

FIG. 2 shows the seat with the foldable table in a closed position, in accordance with one or more embodiments of the present disclosure.

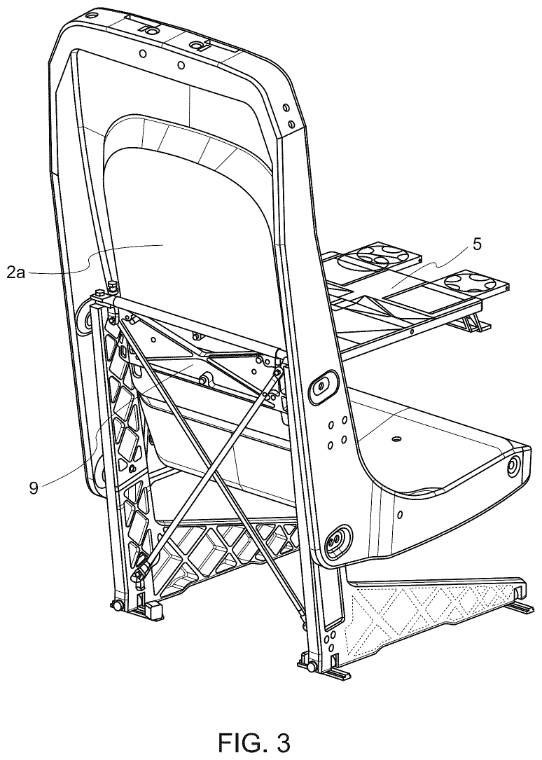

FIG. 3 shows a rear view of the seat with the foldable table in the open position, in accordance with one or more embodiments of the present disclosure.

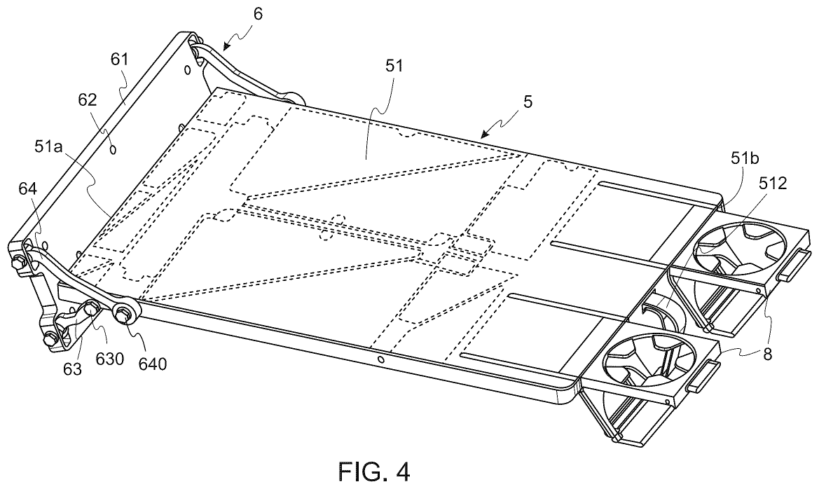

FIG. 4 shows an example of a table, in accordance with one or more embodiments of the present disclosure.

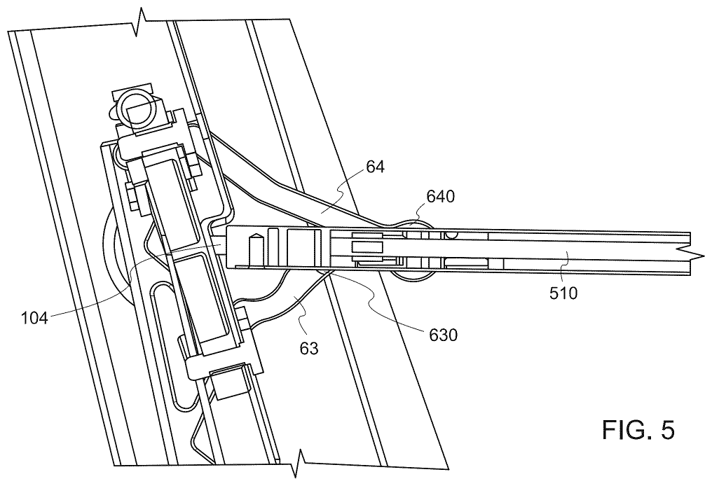

FIG. 5 shows a detailed view of a seat with installed table, in accordance with one or more embodiments of the present disclosure.

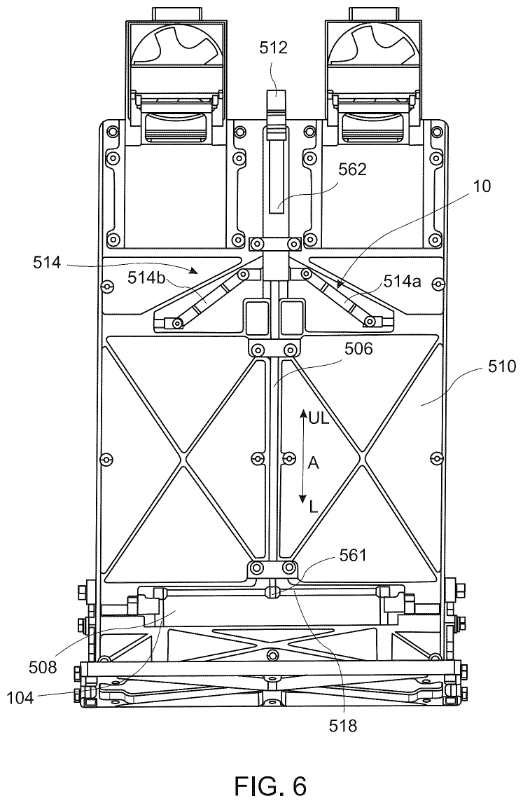

FIG. 6 shows an interior view of a table, in accordance with one or more embodiments of the present disclosure.

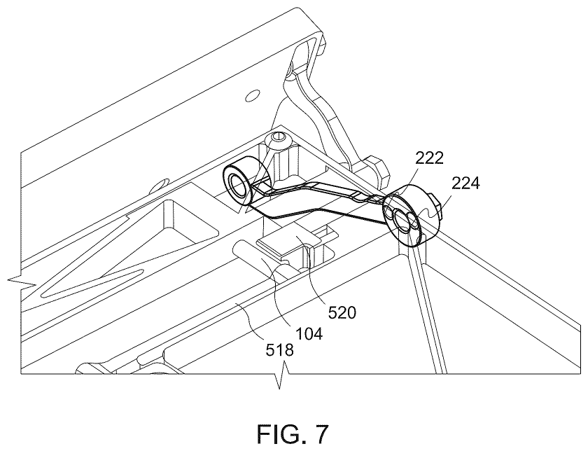

FIG. 7 shows a detailed view of the table of FIG. 6, in accordance with one or more embodiments of the present disclosure.

### DETAILED DESCRIPTION

With reference to FIGS. 1, 2, and 3, the table system according to this disclosure is mounted to a seat back 2 of a seat 1. The seat also has a seat base or seat pan 3. In the example shown, the seat is provided with mounting feet 4 to allow the seat to be mounted to, e.g., floor tracks in a vehicle or aircraft. The table assembly is not, however, limited to use in such seats and can be incorporated into other types of seats for other environments.

The table system includes a table 5 which is mounted by a hinge assembly 6, to be described in more detail below, to the seat back 2 such that the table can be pivoted about the hinge assembly 6 between a closed position (as shown in FIG. 2) where the table 5 is positioned with its table top surface 51 against the seat back 2 and its bottom surface 52 facing outwards towards the user when seated, and an open position (as shown in FIG. 1). The table bottom surface 52 may be provided with cushioning to provide a comfortable back rest when the table is closed/stowed.

To improve the continuity of the seat back when the table is stowed, a recess 7 may be formed in the seat back to accommodate the table when stowed.

The table may also optionally be provided with accessories such as one or more cup holders 8. These can be fitted into slots or rails to slide out from the table when in use and slide back inside the table when not in use, or they can be foldable relative to the table. Alternatively, the top of the table can be provided with cut-outs or recesses to hold cups or drinks. Cup holders are, however, not necessarily provided with the table.

To secure the table in position when stored and, optionally when in the folded out position, a locking system 10 is provided which is largely formed inside the table between its table top surface 51 and its bottom surface 52. This will be described further below.

To provide additional securing of the table to the seat and reinforcement, the table may be mounted to a reinforcement plate 9 provided at the rear 2a of the seat back 2.

The table is shown in more detail in FIG. 4. This shows the table in the open position showing the table top surface 51 extending from a first end 51a adjacent the hinge assembly 6, to a second, opposite end 51b. In the example shown, the cup holders 8 extend from this free second end 51b, but these are an optional feature. The table top surface 51 and the table bottom surface 52 define between then a receptacle (e.g., receptable 510 as shown in FIG. 5) to accommodate the locking system 10, as will be described further below.

The hinge assembly 6 s includes a hinge plate 61 that is arranged to be secured to the seat back 2, e.g., by screws or bolts or other fasteners 62. For a stronger system, the fasteners 62 may pass through the seat back to secure with a reinforcement plate 9 at the rear of the seat.

The hinge assembly may be designed such that there is no fixed pivot point about which the table 5 pivots. Rather, the hinge defines a pivot curve or radius created from multiple instant pivot points. The table can then fold out by first pivoting at a first pivot point and then pivoting about a second pivot point so that the folding table first lifts to clear the cushioning on the table bottom surface before folding out in the opening flat direction. This way, the cushioning does not affect the ease of opening the table to a properly flat position. In the example shown, the moving pivot point is provided by the use of two hinge arms 63, 64 on each side of the table. The first hinge arm 63 is connected to a side of the table at a first pivot point 630 and the second arm 64 is connected to the side of the table at a second pivot point 640. To open the table, the table is first moved in a first direction which is an upward direction relative to the hinge back plate about the second pivot point 640, defining a pivot curve or radius rather than just a single fixed pivot point, to clear or lift above where the cushion is present where the table pivots, and then pivots to the open position about the higher, first pivot point 630. With the multiple pivot points, defining a pivot curve, the whole top surface of the table is then available for use when the table is open.

The locking system 10, which is built into the table, is configured to lock the table in position relative to the seat back and hinge plate when in the closed or stowed position and also to lock the table in its flat, opened out position, relative to the hinge plate, but to allow free movement of the table between those two positions.

The locking system 10 includes two side locking pins 102, one extending from each side of the table at a position intermediate the two ends of the table, and two rear locking pins 104 at the first end of the table. It is also conceivable that the system has more than two side locking pins and/or more than two rear locking pins 104.

The locking system includes an assembly of levers that can best be seen and explained with reference to FIGS. 6 and 7, which show the interior cavity 510 of the table (i.e., with the top surface 51 removed from the drawings for ease of explanation). The assembly of levers includes a central rod 506 that extends along a centreline of the table between the first and second ends. The rod 506 is attached, at a first end 561, to a rear locking mechanism 508 associated with the rear locking pins, and at a second end 562 to an actuator 512 to be operated by a user when opening the table. In this example, the actuator is a tab 512 or strap which may extend from the second end of the table to be grasped by the user for easy manipulation of the locking system. Intermediate the first and the second end or the rod 506, the rod is connected to a side locking mechanism 514 associated with the side locking pins 102.

The side locking mechanism 514 includes two side levers 514a, 514b, each extending out from the rod 506 towards a respective side of the table and pivotally attached to the rod, at one end, at attached to a respective one of the side locking pins at the other end.

The rear locking mechanism 508 includes a rear rod 518 joined to the center rod 506 and extending out towards the sides of the table, where each end of the rear rod is attached to a respective rear locking pin 104.

Operation of the locking mechanism will now be explained in more detail with reference to the examples shown.

When the table is stowed, the locking system is biased to its locked position in which the side locking mechanism causes the side locking pins 102 to extend from the sides of the table and engage in corresponding recesses or detents in the seat back and the rear locking pins extend through the hinge plate 61 into corresponding recesses or detents in the seat back. With reference to arrow A in FIG. 6, the rod would by biased in direction L for the side and rear locking pins to be locked relative to the seat back.

To release the locking system so that the table can be folded out to the open position, the user operates the locking system via the actuator—i.e., in the example, by pulling the tab 512 in a direction away from the second end of the table—i.e., in direction UL (arrow A). The tab preferably protrudes from the table and the rest of the seat back when the table is stowed, and may be in a colour that is different from the seat cushioning, so that the user can easily see and grasp the tab. By pulling the tab, the locking system central rod 506 is also pulled in direction UL. As the central rod moves in the UL direction, it draws in an end of the side levers connected to the central rod up in the same, UL direction. These side levers thus pivot about their respective pivot points thus drawing the side locking pins 102, attached to their other ends, inwards into the table cavity and out of engagement with the recesses/detents in the seat back to unlock the table from the seat back at this point. At the same time, the central rod pulls the rear rod 518 in the UL direction which, in turn, pulls the rear locking pins 104 out of the corresponding recesses/detents in the seat back. The table is then released relative to the seat back to be folded out about the hinge assembly 6, first by an upward movement and then in an opening out movement until the flat open position, such as shown in FIG. 1, is reached.

When the user releases the tab, the central rod 506 returns to its default position in direction L (arrow A). The side levers 514a, 514b then pivot back to their extended position pushing the side locking pins 102 to extend from the sides of the table 5. Provided the table is not stowed in the seat back, there is nothing for these pins 102 to engage with and so they do not function to prevent any movement of the table when out of the stowed position. The rear pins 104, when the central rod is in its default state, will extend in the L direction but will only lock when the table is in the fully opened out position, as described further with reference to FIG. 7. Once the table is fully opened, the rear locking pins 104 will engage in holes in the back of the seat back or in the reinforcement plate, if present.

A spring-loaded mechanism (as shown in FIG. 7) may be provided to ensure that the rear locking system is not actuated during movement of the table between the stowed and the open position. The spring-loaded mechanism includes a spring-loaded pin 520 located between each end of the rear rod 518 and the second hinge arm pivot point. The second hinge arm 64 is provided with two holes 222, 224 spaced around the pivot point of the second arm 64 such that the holes align with the pins only when the table is at the stowed position and at the open position. At all intermediate positions, the spring-loaded pins are biased inwards towards the rear pins 104. Therefore, at all positions of the table between the stowed and the open position, the spring-loaded pins are biased against the respective end of the rear rod which prevents the rear pins from engaging in the recesses/detents. In the stowed and open positions, however, the locking mechanism is actuated and the rear rod 518 pushes the spring-loaded pins outwards where they engage in the holes 522, 524 in the arm. When a user pulls the actuator 512 to unlock the assembly, moving the assembly in the UL direction, the spring-loaded pins 520 are decompressed by their springs and are no longer actuated into the holes in the arms.

The locking system therefore prevents undesired self-opening of the table and also reduces vibration of the table when it is in its open position. The table system is simple, lightweight and compact but also rigid and secure and remains stable in all positions. After closing, the table can lie completely flat in the seat back to provide a comfortable and unobtrusive back rest.

1. A foldable table system for incorporation in a seat back, the system comprising:
a table having a first end and a second end, a table top surface extending from the first end to the second end, a table bottom surface extending from the first end to the second end, and a cavity defined between the table top surface and the table bottom surface;
a hinge assembly connected by pivot arms to the first end of the table about which the table is pivoted between a stowed position and an open position; and
a locking system located within the cavity, the locking system comprising a lever assembly, side locking pins connected to a side locking assembly of the lever assembly, rear locking pins connected to a rear locking assembly of the lever assembly, and an actuator for operation by a user, wherein the locking system is biased to a default state in which the lever assembly drives the side locking pins and the rear locking pins to extend from the table, and wherein operation of the actuator by the user operates the lever assembly to retract the side locking pins and the rear locking pins into the cavity.

2. The system of claim 1, wherein the hinge assembly is arranged to define a pivot curve or radius defined by multiple pivot points, to cause the table to open in a pivot curve when the user operates the actuator.

3. The system of claim 1, wherein the locking system comprises a hinge plate arranged to be secured to the seat back.

4. The system of claim 3, further comprising a reinforcement plate arranged to be fastened to the hinge plate, in use, with the seat back between the hinge plate and the reinforcement plate.

5. The system of claim 1, wherein the locking system comprises two side locking pins, one at each side of the table.

6. The system of claim 1, wherein the locking system comprises two rear locking pins extending from the first end of the table.

7. The system of claim 1, wherein the lever assembly comprises a central rod extending along a centreline of the table between the first end and the second end, the central rod being attached, at a first end, to a rear locking mechanism comprising the rear locking pins, and at a second end to the actuator.

8. The system of claim 7, wherein the lever assembly further comprises a side locking mechanism comprising the side locking pins, intermediate the first end and the second end of the central rod.

9. The system of claim 8, wherein the side locking mechanism comprises two side levers each extending outwards from the central rod to a respective side locking pin.

10. The system of claim 7, wherein the rear locking mechanism comprises a rear rod joined to the central rod and extending out towards the sides of the table where the rear rod is attached to a respective rear locking pin.

11. The system of claim 1, wherein the actuator comprises a strap or tab accessible to the user.

12. The system of claim 1, further comprising a spring-loaded mechanism to lock the table against pivotal movement when in the stowed position and the open position, but to permit pivotal movement between those positions.

13. The system of claim 12, wherein the spring-loaded mechanism comprises two spring-loaded pins associated with respective sides of the rear locking assembly, and corresponding holes in the pivot arms, the two spring-loaded pins arranged to secure in the holes when the table is in the stowed position or the open position.

14. The system of claim 1, further comprising cup holders positioned relative to the table to move between a retracted position relative to the table and an extended position relative to the table.

15. (canceled)

16. A seat comprising:
a seat back, wherein the seat back includes a foldable table system,
wherein the foldable table system comprises:
a table having a first end and a second end, a table top surface extending from the first end to the second end, a table bottom surface extending from the first end to the second end, and a cavity defined between the table top surface and the table bottom surface;
a hinge assembly connected by pivot arms to the first end of the table about which the table is pivoted between a stowed position and an open position; and
a locking system located within the cavity, the locking system comprising a lever assembly, side locking pins connected to a side locking assembly of the lever assembly, rear locking pins connected to a rear locking assembly of the lever assembly, and an actuator for operation by a user, wherein the locking system is biased to a default state in which the lever assembly drives the side locking pins and the rear locking pins to extend from the table, and wherein operation of the actuator by the user operates the lever assembly to retract the side locking pins and the rear locking pins into the cavity.
